(19) United States
(12) Patent Application Publication
(10) Pub. No.: US 2014/0301533 A1
(43) Pub. Date: Oct. 9, 2014

(54) PROTECTIVE SHIELD FOR X-RAY FLUORESCENCE (XRF) SYSTEM

(71) Applicants: James L. Failla, JR., Providence, RI (US); David A. Clifford, Lynnfield, MA (US); Wayne Allen Minter, Peabody, MA (US)

(72) Inventors: James L. Failla, JR., Providence, RI (US); David A. Clifford, Lynnfield, MA (US); Wayne Allen Minter, Peabody, MA (US)

(21) Appl. No.: 14/138,789

(22) Filed: Dec. 23, 2013

Related U.S. Application Data
(63) Continuation of application No. 13/974,684, filed on Aug. 23, 2013.
Application No. 13/974,684 is a continuation-in-part of application No. 13/858,309, filed on Apr. 8, 2013.

(51) Int. Cl. G21K 1/00; G01N 23/223

(52) U.S. Cl. CPC G21K 1/00; G01N 23/223
USPC 378/45; 378/156

(57) ABSTRACT

In one embodiment, a protective shield for a spectrometer is provided. The shield includes a body configured to substantially protect a front of the spectrometer, the body including an aperture that includes a protective mesh. The protective mesh includes a high-strength, low-Z material, such as an arrangement of carbon fibers. A method of fabrication, a spectrometer and a method of using the spectrometer are disclosed.

### BACKGROUND OF THE INVENTION

1. Field of the Invention

The invention relates to an X-ray fluorescence (XRF) system, and in particular, to a protective shield for a window of the system.

2. Description of the Related Art

X-ray fluorescence (XRF) systems are widely used for rapid non-destructive analysis and identification of elemental content in a sample. While some XRF systems are used in the laboratory environment, many XRF systems are used for analysis in the field. For example, XRF technology is commonly used for field analyses of lead content of paint applied in housing. XRF technology is also commonly used for evaluation of materials in a scrap yard. As one might imagine, XRF systems built for field use must be rugged.

Common to all implementations of XRF technology are a source of primary radiation, a detection system, and an analyzer. Exemplary sources of primary radiation include radioisotopes and X-ray tubes. When deployed, the beam of primary radiation from the source is directed at a sample. A majority of the primary radiation is scattered and a portion of it excites the atoms of elements in the sample causing them to emit their characteristic X-rays. Both the scattered and characteristic X-rays are detected by the instrument detection system and subsequently analyzed by the analyzer. In the case of field use equipment, the detection system and other components of the XRF system are typically protected from the environment by a thin window.

The energies of the radiation generated by the various elements that may be contained within the sample are unique to each of the various elements. Accordingly, by knowing the energies of characteristic radiation emitted by elements in the sample, it is possible to determine elemental content of each sample. Characteristic X-rays of some elements, specifically those with low atomic number Z (Z<20) have very low energies and therefore, are easily absorbed by any substance, even by air. Consequently, designers of XRF systems strive to shorten the distance between the sample and the detecting system to an absolute minimum and use in this space only materials that exhibit little attenuation of low energy X-rays.

Accordingly, in the case of field instrumentation, the protective window is usually very thin in the sense of attenuation/absorption of X-rays. Minimizing density and thickness of the window material improves instrument performance in two ways. First, a thinner and less dense window will provide less attenuation of the low energy X-ray signal returning to the detector from the sample, resulting in improved sensitivity and lower limits of detection. Second, a thinner, less dense window will produce less scattered radiation of the primary beam, thus resulting in a lower background signal in the detector arising from Compton scattering.

In use, it is advantageous to place the detecting system of the instrument as close as possible to the sample. As a matter of fact, all XRF instruments designed for field use usually require that the window of the instrument be placed in contact with the sample. This frequently leads to breakage of the thin window, especially when the sample has an irregular shape or sharp, protruding parts.

What are needed are methods and apparatus for providing XRF instruments with robust physical protection of a window, while presenting a minimal interference with characteristic radiation emitted by a sample.

### SUMMARY OF THE INVENTION

In one embodiment, a protective shield for a spectrometer is provided. The shield includes a body configured to substantially protect a front of the spectrometer, the body including an aperture that includes a protective mesh. The protective mesh includes a high-strength, low-Z material.

In another embodiment, a method for fabricating a protective shield for a spectrometer is provided. The method includes: configuring a body for mounting to the spectrometer and substantially protecting a front of the spectrometer; and incorporating a protective mesh that includes a high-strength, low-Z material into an aperture of the body.

In yet another embodiment, an X-ray fluorescence spectrometer is provided. The spectrometer includes an opening in a housing for at least one of providing primary radiation and receiving characteristic emissions from a sample, the housing including a mount for mounting a protective shield thereon. The spectrometer also includes a protective shield for mounting to the housing, the protective shield including a body and an aperture that also includes a protective mesh, the body configured for substantially protecting a front of the spectrometer, the protective mesh including at least one of carbon fibers, beryllium, boron nitride, and a para-aramid synthetic fiber.

In a further embodiment, a spectrometer includes an X-ray source to direct X-rays to a sample; a detector to receive X-rays from the sample; and a protective shield that includes a protective mesh through which passes both X-rays from the source to the sample and from the sample to the detector, the protective mesh including a high-strength, low-Z material.

In some embodiments the protective shield does not add any peak in a spectrum from an aluminum sample when irradiated from a silver anode x-ray source, which is greater than 5% (or greater than 3%, 2%, or 1%) of the maximum amplitude of a Ka (“K alpha”) line for the aluminum sample.

In yet another embodiment, a method of using a spectrometer is provided. The spectrometer includes an X-ray source to direct X-rays to a sample; a detector to receive X-rays from the sample; a protective shield that includes a protective mesh through which passes both x-rays from the source to the sample and from the sample to the detector. The method includes using the spectrometer for directing X-rays from the source through the mesh to the sample; receiving at the detector X-rays produced from the sample and which have passed through the mesh; wherein wherein the protective mesh does not add any peak in a spectrum of the X-rays from the sample which is greater than about 5% (or greater than 3%, 2% or 1%) of the maximum amplitude of the peak with the highest amplitude appearing in the range of between about 0 keV to about 30 keV.

### BRIEF DESCRIPTION OF THE DRAWINGS

The features and advantages of the invention are apparent from the following description taken in conjunction with the accompanying drawings in which:

FIG. 1 is an isometric diagram of a handheld XRF system including a protective shield according to the teachings herein;

FIG. 2 is an isometric view of a prior art window bracket;

FIG. 3 is an isometric view of an uninstalled protective shield;

FIG. 4 is a cross-sectional view of an embodiment of the protective shield; and,

FIGS. 5 and 6 are graphs depicting comparative performance for embodiments of a spectrometer without the protective shield according to the teachings herein, and with the protective shield.

### DETAILED DESCRIPTION OF THE INVENTION

Disclosed herein are methods and apparatus that provide a protective shield for an X-ray fluorescence (XRF) device. Generally, the protective shield may be configured for use with a handheld or portable XRF device. Advantageously, the protective shield exhibits a low mass density thickness, and therefore causes minimal attenuation of fluorescence signals from a sample.

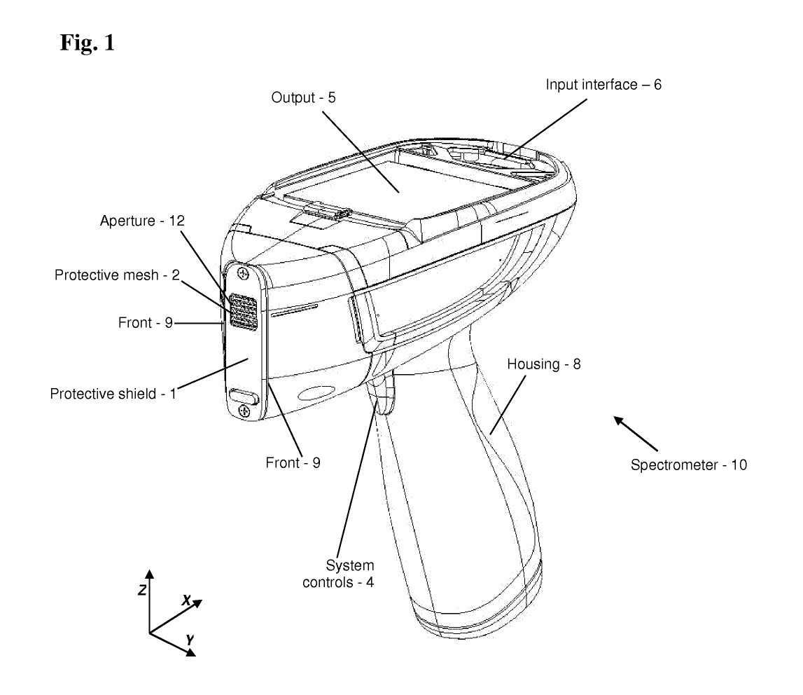

Referring now to FIG. 1, there is shown an exemplary spectrometer 10. In this example, the spectrometer 10 is an X-ray fluorescence (XRF) device. In particular, the exemplary spectrometer 10 is a handheld XRF device. While the teachings here are presented in the context of a handheld XRF device, this is merely illustrative and is not limiting. Accordingly, the protective shield and other aspects may be practiced with devices other than a handheld XRF device. Exemplary other devices include laboratory-based XRF devices.

In the exemplary embodiment depicted in FIG. 1, the handheld XRF device is contained within a housing 8. The handheld XRF device includes an input interface 6 for manipulation of the device. The input interface 6 may include at least one pushbutton, touchscreen, or other such device for adjusting settings of the spectrometer 10. A user may monitor settings of the spectrometer 10 by viewing output 5. The output 5 may include a screen, such as an LCD screen. The output 5 may further include a speaker, such as one configured to provide auditory output such as an alarm. The output 5 may include a network interface such as an Ethernet, serial, parallel, 802.11, USB Bluetooth or other type of interface (not shown). The spectrometer 10 may include an internal power supply (e.g., a battery), memory, a processor, a clock, data storage, and other similar components. Generally, the processor is configured to receive input from system controls 4 and to control the radiation source, a detection system and analysis components. Accordingly, the processor will also provide appropriate information to the output 5. The spectrometer 10 may be configured to take advantage of robust processing capabilities, and may therefore include data libraries, substantial memory for data storage, calibration libraries and the like. System controls 4 may include a trigger or other such device to provide for initiation of sampling and analysis with the spectrometer 10. The output 5 may provide raw data, spectral data, concentration data and other appropriate forms of data.

Also shown in FIG. 1 is an embodiment of a protective shield 1. The protective shield 1 includes an aperture 12 that includes a protective mesh 2. In the exemplary embodiment, the protective shield 1 protects a front 9 of the spectrometer 10. Generally the front 9 includes at least one access way (e.g., with a window disposed thereover, not shown). The access way provides for access to an internal radiation source, detection components and analyzer components. Accordingly, the protective shield 1 may be configured to provide protection for the at least one access way, and generally protect the front 9 of the spectrometer 10.

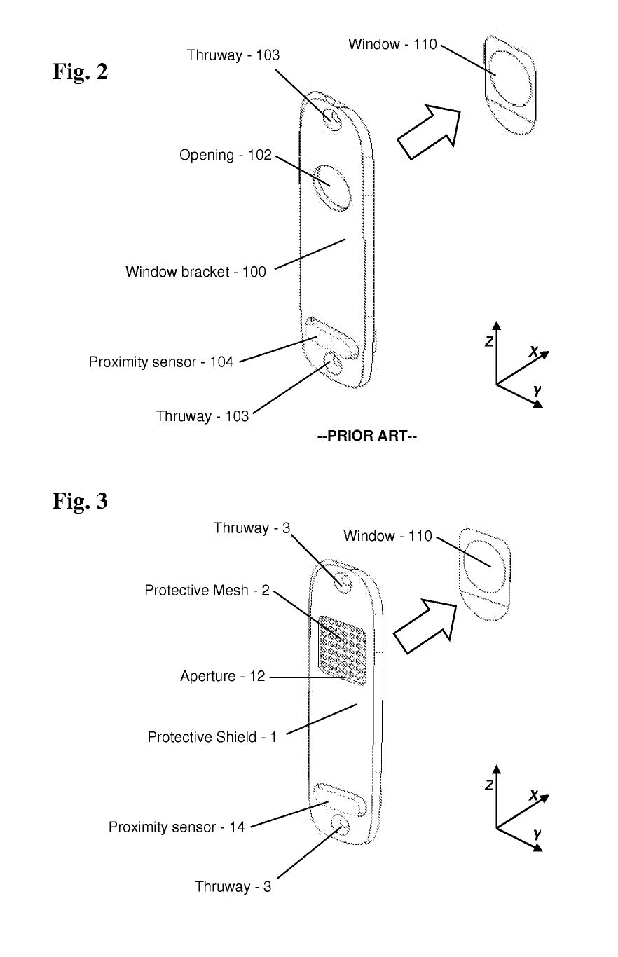

Referring now to FIG. 2, an exemplary prior art window bracket 100 is shown. A window 110 for the XRF device includes a thin film that is placed over an opening in the window bracket 100. Typically, the window 110 is a polypropylene film of a thickness of about four (4) microns. The window 110 may be adhered to the window bracket 100 by a pressure sensitive adhesive along the edges. The window bracket 100 has an opening 102 that is a single aperture to enable passage of X-rays without attenuation. In turn, the window bracket 100 is mounted to the spectrometer 10 (XRF device). In one example, the window bracket 100 includes at least one thruway 103. Each thruway 103 may be configured to receive a screw (not shown) to screw the window bracket 100 to the spectrometer 10. In some embodiments, at least one proximity sensor 104 may be included.

As discussed above, this design is problematic. That is, in practice, a user may very often puncture the window 110 by pressing the XRF device against an irregular shaped sample. When a portion of the sample protrudes through the opening 102, it breaks the window 110. Accordingly, protecting the spectrometer 10 requires removing the window bracket 100 and replacing the window 110. This is time-consuming, costly, and risks damaging the spectrometer 10 if servicing is performed in the field.

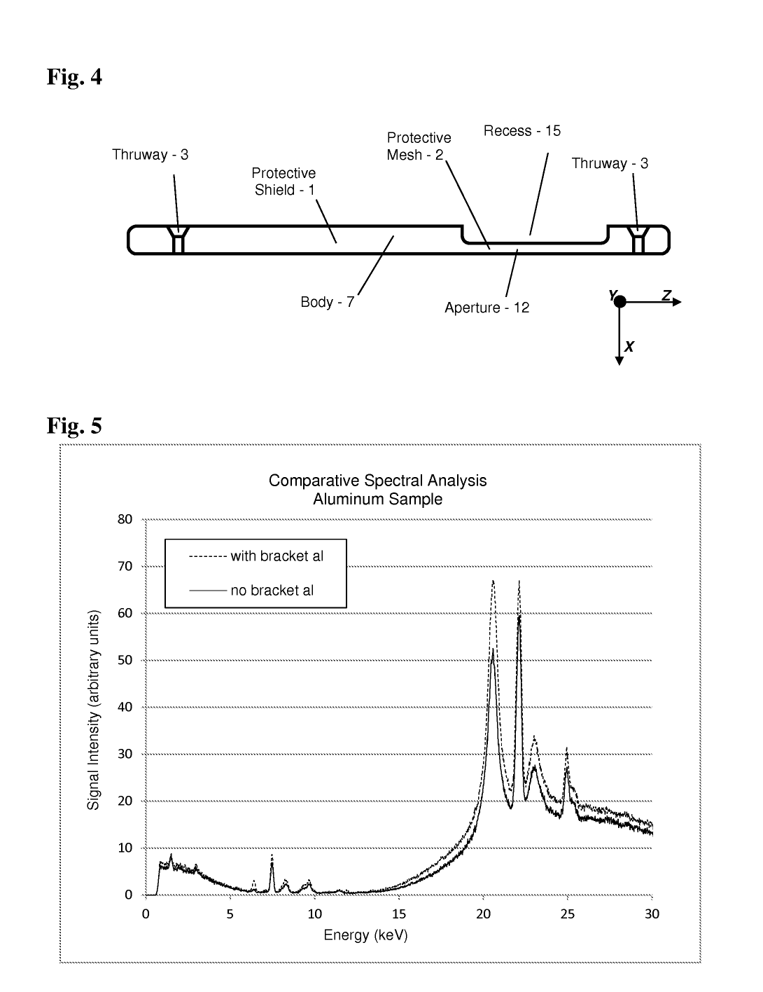

Referring now to FIG. 3, a protective shield 1 according to the teachings herein is illustrated. In this example, the protective shield 1 is provided in the geometry that is suited for replacement of the prior art window bracket 100. That is, the protective shield 1 may have a shape and size that is similar to the prior art window bracket 100. Additionally, the protective shield 1 may include at least one thruway 3. Each thruway 3 may be configured to receive a screw (not shown) to screw the protective shield 1 to the spectrometer 10. In some embodiments, at least one proximity sensor 4 may be included.

The protective shield 1 includes a protective mesh 2 disposed in an aperture of the protective shield 1. In this example, the protective mesh 2 is fabricated from carbon fiber. Use of carbon fiber provides a mechanically high strength barrier to protect the window 110 from physical damage.

During fabrication, the protective mesh 2 may be fabricated with substantially continuous fibers orthogonally oriented in a layup of 0 degrees and 90 degrees. The layup may include a plurality of layers of the carbon fibers. By bundling and spacing of the carbon fibers in the layup, a regular pattern of holes results in the protective mesh 2. By incorporation of the protective mesh 2, the protective shield 1 limits or prevents damage of the window 110.

At least one proximity sensor 4 may be incorporated to provide for adequate standoff from a sample, to enhance physical strength of the protective shield 1 and, in some embodiments, may be omitted from the protective shield 1. In some embodiments, the proximity sensor 4 must be activated prior to generation of the primary radiation. Accordingly, the proximity sensor 4 is a safety device, and may serve other functions as well.

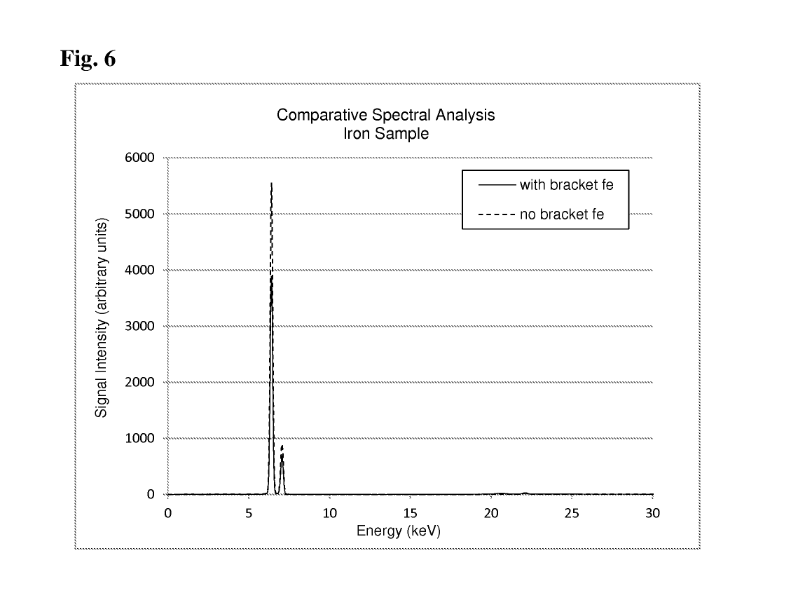

Referring now to FIG. 4, there is shown a cross-sectional view of the protective shield 1. In this example, it may be seen that the protective shield 1 includes a recess 5. The recess 5 may provide for an implementation of a comparatively thin protective mesh 2. That is, it may be considered that a cross-section of the protective mesh 2 is thin in comparison to a cross-section of a body 7 of the protective shield 1.

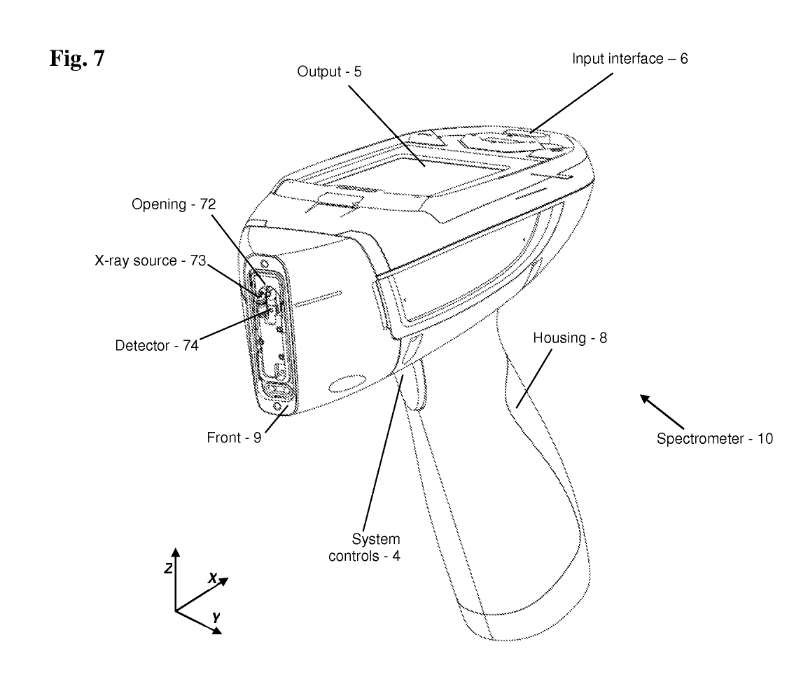

Accordingly, the protective shield 1 exhibits a relatively high strength and low mass density thickness, thus minimizing interference with the X-ray source, as well as characteristic emissions from a sample. Reference may be had to FIGS. 5 and 6.

FIGS. 5 and 6 are graphs depicting spectra obtained by the spectrometer 10. Each graph includes a sample analysis spectrum from the spectrometer 10 without an installed protective shield 1. Also included in each graph is a sample analysis spectrum from the spectrometer with the protective shield 1. FIG. 5 depicts performance of the spectrometer 10 for a sample of aluminum. FIG. 6 depicts performance of the spectrometer 10 for a sample of iron.

Review of the comparative performance shows that the protective shield 1 exhibits very little X-ray fluorescence. Additionally, it should be recognized that calibration of the spectrometer 10 may be performed to account for use of the protective shield 1, and to minimize influence of the protective shield 1 on spectroscopy.

TABLE 1
Net Effect on Measured Intensity of X-ray Fluorescence

| Atomic | | Primary | Intensity Ratio |
|---|---|---|---|
| Number (Z) | Element | Emission (keV) | Unshielded/Shielded |
| 22 | Ti | 4.5 | 2.06 |
| 26 | Fe | 6.4 | 1.46 |
| 29 | Cu | 8 | 1.22 |
| 42 | Mo | 17.4 | 1.04 |
| 47 | Ag | 22.1 | 1.01 |

Table 1 shows the net effect on the measured intensity of X-ray fluorescence lines from several elements. The ratio is the intensity of the line measured without the protective shield 1 versus the intensity of the line measured with the protective shield 1 in place on the spectrometer 10. As the element increase in weight (atomic number, Z), the characteristic X-rays increase in energy and the loss in measured signal diminishes. An intensity ratio of 2.06, the worst shown, does not adversely affect capability to identify an element. This is shown in table 2 below, where a titanium alloy is shown to be correctly identified.

Generally, the protective mesh 2 may be characterized as a structure made of strands of carbon fiber with evenly spaced openings between them. However, is not required that the protective mesh 2 have evenly spaced openings. Nor is it required that the protective mesh 2 be fabricated entirely from carbon fiber. For example, fiber in the protective mesh 2 may include some degree of impurities, and may include polymers, binders, and any other material deemed appropriate. In some embodiments, the protective mesh 2 includes materials that are “low Z” materials. That is, the protective shield 1 includes materials that are lightweight materials formed from elements having relatively few protons in the nucleus. Exemplary materials include beryllium, boron nitride and KEVLAR, a para-aramid synthetic fiber available from DuPont Chemical of Wilmington Del. Other materials, such as other fibers that exhibit desirable properties may be used in the protective shield 1.

As discussed herein, the term “low-Z” generally refers to materials having an atomic number of less than about nine (9), but this is not a strict requirement. For example, low-Z materials may include a composition that primarily includes materials with atomic numbers of less than about nine (9), with some additional materials such as binders, additives, dopants or contaminants which have atomic numbers higher than about nine (9). For ease of referencing, elements and associated atomic numbers are: hydrogen-1; helium-2; lithium-3; beryllium-4; boron-5; carbon-6; nitrogen-7; oxygen-8; and fluorine-9.

Additionally, the term “low fluorescence” generally refers to limited introduction (or, stated another way, substantially no addition of spurious fluorescence or scattering in spectral data that is attributable to the protective shield 1. “Spurious” in this context, references peaks (including background) in the spectrum that are generated as a result of the material composition or structure of the shield or mesh as opposed to non-spurious peaks that are generated as a result of the material composition or structure of the sample under test. In some embodiments, fluorescence from the protective mesh 2 may result in addition of a peak in the spectrum that is less than about five percent (5%), or even less than 3% or 2% of the maximum amplitude of the maximum amplitude of the peak with the highest amplitude appearing in the range of between about 0 keV to about 30 keV.

As discussed herein, statements to the effect of “a protective shield does not add any peak in a spectrum” generally reference a protective shield that does not add a peak in any part of the described spectrum beyond a tolerable size, whether that added peak is a separate peak or partially or completely overlaps with another peak in that spectrum.

In some embodiments, the protective mesh 2 includes a weave of fibers (and thus exhibits an appearance similar to that of a woven screen). Generally, the protective mesh 2 provides a balance of a strong physical barrier (that minimally interferes with primary or characteristic radiation) and an unabated pathway to the window 110.

A body of the protective shield 1 may be fabricated from any material deemed appropriate. In some embodiments, the body of the protective shield 1 is also fabricated from carbon fiber. In some embodiments, the body of the protective shield 1 is fabricated from a carbon fiber composite of all low density material. Generally, material selected for the body of the protective shield 1 is chosen to minimize incorporation of heavy elements and thus reducing background noise in the detection system due to Compton scattering and spurious X-ray fluorescence.

A demonstration of comparative efficacy of detection and performance of the instrument equipped with a conventional window (prior art system) and the instrument equipped with the protective shield 1 is provided in Table 2.

TABLE 2
Comparative Evaluation of Materials

| | Conventional Window | | Protective Shield | |
|---|---|---|---|---|
| | Properly | Matching | Properly | Matching |
| Sample Material | identified? | Factor | identified? | Factor |
| Stainless Steel 301 | Yes | 0.00 | Yes | 0.88 |
| Stainless Steel 310 | Yes | 1.28 | Yes | 0.00 |
| Stainless Steel 347 | Yes | 0.00 | Yes | 1.77 |
| Titanium Alloy 6-2-4-2 | Yes | 2.33 | Yes | 2.52 |
| 63% Sn/37% Pb Alloy | Yes | 4.37 | Yes | 3.62 |
| Hastelloy ® C-276 | Yes | 0.00 | Yes | 0.00 |
| Nickel-based Alloy | | | | |
| Nitronic ® 50 Stainless | Yes | 0.00 | Yes | 0.00 |
| Steel | | | | |
| CDA-932 High Leaded | Yes | 2.04 | Yes | 0.23 |
| Tin Bronze | | | | |
| RA333 ® High | Yes | 0.00 | Yes | 0.00 |
| Chromium Nickel Alloy | | | | |
| Nimonic ® 263 Nickel | Yes | 3.48 | Yes | 3.17 |
| Alloy | | | | |

Referring to Table 2, it may be seen that the spectrometer 10 equipped with the protective shield 1 properly identified each sample. With regards to the matching factor, smaller is better, with 0.00 being the best possible value. In short, it may be seen that the protective shield 1 does not substantially impact performance of the spectrometer 10.

It should be noted that Hastelloy, Nitronic, RA333, and Nimonic are registered trademarks, belonging to their respective owners. The CDA in CDA-932 stands for Copper Development Association, an industry trade group that has established naming conventions for copper alloys.

Having introduced the protective shield 1, some aspects of additional embodiments are provided.

The protective shield 1 may be provided as equipment for retrofit of an existing spectrometer 10, or as an original equipment manufacturer's component.

In some embodiments, the protective shield 1 includes a plurality of apertures protected with protective meshes 2. For example, in some embodiments, a particular spectrometer 10 may have a primary window for providing primary radiation and another window for receiving characteristic radiation.

Fibers incorporated into the protective mesh 2 may have a different orientation. For example, the fibers may be substantially oriented at 0 degrees, 30 degrees, 60 degrees and 90 degrees (i.e., the fibers may have an angular orientation). It should be considered that angles of orientation presented herein are general and not to be considered with great deal of precision or accuracy. That is, it is considered that fibers included in the protective mesh 2 may include some level of disarray as may occur in commonly produced embodiments of carbon fibers. In some embodiments, orientation of each of the strands of carbon fiber is random in relation to each other or “disoriented.” Generally, orientation of the carbon fibers or other fibers as may be used in the protective mesh 2 is provided in a manner the results in adequate physical strength for use of the spectrometer 10 in a physically challenging environment, such as in field use.

In order to provide some additional detail on materials that may be used in the protective shield 1, consider the following on carbon fibers. Carbon fibers are formed of carbon atoms bonded together to form a long chain. Examples include various nano-forms of carbon, including carbon nanotubes. The fibers are extremely stiff, strong, and light, and exhibit superior physical properties. Carbon fiber material may be commercially obtained in a variety of forms, including yarns, uni-directional sheets, weaves, braids, and several others.

A basic plain-weave carbon fiber panel exhibits a stiffness-to-weight ratio that is about eighteen percent (18%) greater than aluminum and about fourteen percent (14%) greater than steel.

Carbon fiber is extremely strong. Stiffness of a material is measured by its modulus of elasticity. The modulus of carbon fiber is generally about 20 msi (138 GPa) and its ultimate tensile strength is typically 500 ksi (3.5 GPa). Compare this with 2024-T3 Aluminum, which has a modulus of 10 msi and ultimate tensile strength of 65 ksi, and 4130 Steel, which has a modulus of 30 msi and ultimate tensile strength of 125 ksi.

High stiffness and high strength carbon fiber materials are also available through specialized processes with much higher values. Generally, it should be considered that referring to any material as “high strength” references “high specific strength” as compared to other materials. “Specific strength” is a material's strength per unit area at failure divided by its density. This is also known as strength-to-weight ratio. As presented above, carbon fiber-based materials exhibit high strength in comparison to embodiments of aluminum and steel. In some embodiments, it may be considered that a high strength material may include any material exhibiting a stiffness that exceeds about 10 msi, and a ultimate tensile strength of at least 65 ksi. Further, in some embodiments, strength may also be considered as a function of material density. Volumetric densities of suitable materials for example may be at least about 1.3 gm/cm³ (83 lbs/ft³), or at least about 2.7 gm/cm³ (169 lbs/ft³), or at least 7.8 gm/cm³ (489 lbs/ft³). Accordingly, in some embodiments, carbon fiber materials are high strength when compared with alloys of steel.

Carbon fiber has a volumetric density of about 1.3 gm/cm³ (83 lbs/ft³), aluminum is about 2.7 gm/cm³ (169 lbs/ft³), and the density of 4130 steel is about 7.8 gm/cm³ (489 lbs/ft³). Thus, carbon fiber is an excellent material for use in the protective shield 1. That is, use of carbon fiber results in a protective shield 1 that includes substantially less material than in the prior art, and therefore does not substantially impede the primary radiation and the characteristic X-rays emitted from a sample.

Various binders may be used to bind the carbon fibers into better provide for shaping of a composite component. In some embodiments, epoxy resin is used as the binder. Various forms of epoxy resin may be used, and additives may be included in the epoxy. Advantageously, epoxy resin is extremely flexible, and the flexibility allows a carbon fiber product to absorb a high level of impact force without breaking. When epoxy reaches a maximum bending potential (MBP), the resin will form only a single crack at the stress point. Epoxy resin may be provided with a transparent finish that allows appearance of the carbon fiber to show through. Additionally, epoxy resin generally does not shrink and is substantially resistant to degradation by exposure to ultraviolet (UV) light. Epoxy selection may consider longer or shorter cure times and enhancement to fracture toughness through use of additives.

A composite sandwich that includes carbon fibers combines the superior strength and stiffness properties of carbon fiber (or another fiber reinforced material, such as glass or aramid) with a lower density core material. By strategically combining these materials, one is able to create a final product with a much higher bending stiffness to weight ratio than with either material alone.

In some embodiments, the protective shield is fabricated from a composite sandwich of material. Accordingly, when considering the strength of one type of material over another, use of a composite sandwich of material permits incorporation of a very thin layer of material in the protective shield 1. As a result, there is substantially less material present to impede the primary radiation and the characteristic X-rays emitted from a sample.

In some embodiments, the materials used in the protective shield are selected such that the protective mesh 2 does not add any peak in a spectrum from a particular sample. For example, the materials used may be selected such that the protective shield 1 does not add any peak to an aluminum sample irradiated from a silver anode X-ray source. More specifically, materials used in the protective mesh 2 may be selected or formulated such that the protective shield 1 does not add any peak in a spectrum of the X-rays from the sample which is greater than about five percent (5%) of the maximum amplitude of the peak with the highest amplitude appearing in the range of between about 0 keV to about 30 keV, when compared with a bare spectrometer 10 (i.e., a spectrometer 10 without the protective shield 1).

In some embodiments, the protective mesh is first fabricated as a thin layer of material, and then perforated such as by drilling into the thin layer. In some embodiments, the protective mesh is actually a very thin layer of, for example made of composite materials, with no holes or openings. In these or other embodiments, use of the window may be excluded. In some embodiments, the protective mesh 2 includes a plurality of square openings. For example, the protective mesh 2 may be fabricated as a weave or in another similar type of geometry such that the openings in the protective mesh 2 are substantially square. One way to achieve this result is to provide a plurality of substantially aligned fibers that are orthogonally oriented with a second plurality of substantially aligned fibers. Advantageously, this results in a protective mesh 2 with a superior porosity (i.e., a ratio of material to openings, and may be expressed as a percentage of openings for a given area), and therefore presents less material in a pathway of the primary radiation or radiation emitted from the sample. In some embodiments, porosity of the protective mesh 2 is at least 40%.

The orthogonal orientation may be provided such that rows and columns of openings are realized. It is not necessary that the rows and columns are oriented in any particular manner with respect to the protective shield 1 or the spectrometer 10. Whether providing the protective mesh 2 as an array of orthogonally oriented fibers, a weave, a composite or in any other of a variety of embodiments, it is possible to arrange the fibers such that the fibers are substantially continuous throughout the protective mesh 2, and therefore are not substantially weakened by the openings. Accordingly, it is possible to include openings of a variety of shapes and sizes. The openings may be round, square, or include any number of sides desired and possible to manufacture (described as an “n-gon,” or as being “n-gonal” in appearance).

One way to make a weave with appropriately dimensioned openings is to bundle a plurality of fibers into separate bundles. A spacing is left between each bundle to provide a respective grouping of bundles. By cross weaving a first grouping with a second grouping, one may provide a weave that includes a plurality of substantially square holes. By controlling dimensions of the spacing during the weaving process, it is possible to control and configure dimensions of the resulting substantially square holes. By controlling orientation of the groupings, as well as a number of groupings included in the weave, this technique may be used to provide weaves that include holes of any desired shape.

In another embodiment, the protective mesh 2 is formed by distributing the carbon fibers onto a substrate mold (not shown). In this example, the mold may include a substantially planar surface with a plurality of upwardly extending protrusions. Each one of the upwardly extending protrusions will result in an opening in the protective mesh 2. Once an appropriate thickness of the fibers has been distributed onto the substantially planar surface, an appropriate binder may then be applied to bind the carbon fibers. Once the binder has cured, the protective mesh 2 may be removed from the mold and incorporated into the protective shield 1. In some embodiments, binder is first applied to the substrate mold, and may also be applied as a final layer. In some embodiments, the protective mesh 2 is finished after being removed from the mold (such as with a final coat, and/or by polishing).

The protective shield 1 is not limited to use with a hand-held spectrometer 10. Such descriptive terminology is not meant to imply limitations on use of the protective shield 1.

In some embodiments, the protective shield 1 does not include the at least one thruway 3. Some other techniques for mounting the protective shield 1 include use of embedded magnets in the protective shield 1. In these embodiments, the embedded magnets align with a magnetic portion of the housing 8 and serve to retain the protective shield 1 in place while in use and to also permit rapid installation and removal of the protective shield 1. In some embodiments, an RFID antenna is included in the protective shield 1. Use of the RFID may be used to ensure appropriate matching of each protective shield 1 with a respective spectrometer 10, and/or identify the presence of the protective shield 1 on the spectrometer 10.

In short, a variety of methods and apparatus are available for ensuring appropriate mounting and removal of the protective shield 1. Other exemplary mounting systems include use of clips, wing nuts, snaps and various other types of fasteners.

In some embodiments, performance of the spectrometer 10 is adjusted for use of the protective shield 1. That is, the spectrometer 10 may be calibrated with the protective shield 1 in place. The spectrometer 10 may also be calibrated without the protective shield 1. A user may simply adjust controls on the input interface 6 to account for use of the protective shield 1. In some embodiments, such as where magnetic mounting is provided, the spectrometer 10 may automatically identify presence of the protective shield 1. In these embodiments, the spectrometer 10 may further include a library of calibration data, thus making each protective shield 1 interchangeable between a plurality of spectrometers 10. Thus, a user may be provided with a well protected spectrometer 10 and an ability to remove the protective shield 1 when appropriate, such as to increase sensitivity.

In some embodiments, a method for fabricating a protective shield for a spectrometer is provided. The method includes configuring a body for mounting to the spectrometer and substantially protecting a front of the spectrometer; and incorporating a protective mesh including a high-strength, low-Z material into an aperture of the body. In some of these embodiments, the material substantially includes elements having an atomic number that is not greater than nine (9). In some of these embodiments, the material substantially includes at least one element selected from the group that includes: hydrogen, beryllium, boron, carbon, nitrogen, oxygen and fluorine. In some of these embodiments, the protective mesh includes at least one of carbon fibers, beryllium, boron nitride, and a para-aramid synthetic fiber. In some of these embodiments, the protective mesh includes at least one of: an arrangement of orthogonally oriented carbon fibers, an angular arrangement of carbon fibers, disoriented carbon fibers, and a plurality of layers of carbon fibers. In some of these embodiments, the configuring includes providing an aperture in the body to align with a window of the spectrometer. In some of these embodiments, the method further includes incorporating at least one of a magnet and a radiofrequency identification (RFID) device into the body.

As discussed herein, the term “X-ray source” generally refers to equipment used for generation of X-rays. However, in some embodiments, an XRF device may use a radioisotope which may emit gamma rays or X-rays (in addition to or in place of the X-ray source). Generally, “X-ray” refers to electromagnetic radiation having a wavelength in the range of about 10 picometers (pm) to about 1 nanometer (nm), while “gamma rays” include electromagnetic radiation having a wavelength shorter than about 10 picometers (pm). In terms of energy, the range of electromagnetic radiation attributed to X-rays stretches from about 1 keV to about 100 keV.

It will be understood that the term “mesh” does not necessarily imply that the mesh is woven or have the appearance of being woven. Furthermore, as described above, the “mesh” may have no openings. For example, the mesh may be a thin layer with or without openings that meets one or more of the properties described herein, such as any one or more of the described properties of high-strength, low-Z, low fluorescence, or of not adding a peak in a spectrum greater than a value described herein. However, in many embodiments the mesh will have a number of openings (for example, more than 1, 2 or 4 per square centimeter).

It will be appreciated that any embodiment of the present invention may have features additional to those cited. Sometimes the term “at least” is used for emphasis in reference to a feature. However, it will be understood that even when “at least” is not used, additional numbers or types of the referenced feature may still be present. The order of any sequence of events in any method recited in the present application is not limited to the order recited. Instead, the events may occur in any order, including simultaneously, which is logically possible.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A protective shield for a spectrometer, the protective shield comprising:
a body comprising a mounting system for mounting the body to the spectrometer, the body configured to mount to and to substantially protect a front of the spectrometer, the body including an aperture comprising a protective mesh, the protective mesh comprising a high-strength, low-Z material for preventing physical damage to a window of the spectrometer.

2. The protective shield as in claim 1, wherein the material comprises at least one of carbon fibers, beryllium, boron nitride, and a para-aramid synthetic fiber.

3. The protective shield as in claim 1, wherein the material comprises at least one of: an arrangement of orthogonally oriented carbon fibers, an angular arrangement of carbon fibers, disoriented carbon fibers, and a plurality of layers of carbon fibers.

4. The protective shield as in claim 1, wherein the material comprises an arrangement of orthogonally oriented carbon fibers with a pattern of openings there-through, the openings arranged in rows and in columns.

5. The protective shield as in claim 4 wherein the openings comprise at least one of round openings, square openings, and n-gonal openings.

6. The protective shield as in claim 1, wherein the protective mesh comprises a plurality of substantially square openings.

7. The protective shield as in claim 1, wherein porosity of the protective mesh is at least forty percent (40%).

8. The protective shield as in claim 1, wherein the body further comprises at least one of: a magnet, and a radiofrequency identification (RFID) device.

9. The protective shield as in claim 1, wherein the body is configured to be interchangeable within a plurality of bodies.

10. The protective shield as in claim 1, wherein the protective mesh is configured to exhibit minimal X-ray fluorescence during sampling with the spectrometer.

11. The protective shield as in claim 1, wherein the protective mesh is configured to not add any peak in a spectrum from an aluminum sample when irradiated from a silver anode x-ray source, which is greater than 5% of the maximum amplitude of a Ka line for the aluminum sample.

12. An X-ray fluorescence spectrometer comprising:
a housing comprising an opening therein, the opening for at least one of providing primary radiation and receiving characteristic emissions from a sample, the housing further including a mount for mounting a protective shield thereon; and
a protective shield for mounting to the housing, the protective shield comprising a body and an aperture comprising a protective mesh, the body configured for substantially protecting a front of the housing, the protective mesh comprising at least one of carbon fibers, beryllium, boron nitride, and a para-aramid synthetic fiber.

13. The X-ray fluorescence spectrometer as in claim 12, configured as a hand-held device.

14. The X-ray fluorescence spectrometer as in claim 12, configured for field use.

15. The X-ray fluorescence spectrometer as in claim 12, wherein the protective shield is interchangeable within a plurality of similar protective shields.

16. The X-ray fluorescence spectrometer as in claim 15, wherein the X-ray fluorescence spectrometer is adapted for recognizing the protective shield and adjusting a calibration accordingly.

17. A spectrometer comprising:
an X-ray source to direct X-rays to a sample;
a detector to receive X-rays from the sample; and,
a protective shield comprising a protective mesh through which passes both X-rays from the X-ray source to the sample and from the sample to the detector, the protective mesh comprising a high-strength, low-Z material.

18. The spectrometer according to claim 17, wherein the spectrometer is calibrated for X-rays received when the protective shield is in place and when the protective shield is removed from the spectrometer.

19. The spectrometer according to claim 17, wherein the protective mesh does not add any peak in a spectrum from an aluminum sample when irradiated from a silver anode x-ray source, which is greater than 5% of the maximum amplitude of a Kα line for the aluminum sample.

20. A method of using a spectrometer, the spectrometer comprising:
an X-ray source to direct X-rays to a sample;
a detector to receive X-rays from the sample; and
a protective shield comprising a protective mesh through which passes both X-rays from the X-ray source to the sample and X-rays from the sample to the detector;
the method comprising:
directing X-rays from the source through the protective mesh to the sample;
receiving at the detector X-rays produced from the sample and which have passed through the protective mesh;
wherein the protective mesh does not add any peak in a spectrum of the X-rays from the sample which is greater than five percent (5%) of the maximum amplitude of the peak with the highest amplitude appearing in the range of between 0 keV to 30 keV.

21. The method as in claim 20, wherein the protective mesh is formed of material substantially comprising elements having an atomic number that is not greater than nine (9).

22. The method as in claim 20, wherein the protective mesh is formed of material substantially comprising at least one element selected from the group comprising: hydrogen, beryllium, boron, carbon, nitrogen, oxygen and fluorine.

23. The method as in claim 20, wherein the protective mesh comprises at least one of carbon fibers, beryllium, boron nitride, and a para-aramid synthetic fiber.

24. The method as in claim 20, wherein the protective mesh comprises at least one of: an arrangement of orthogonally oriented carbon fibers, an angular arrangement of carbon fibers, disoriented carbon fibers, and a plurality of layers of carbon fibers.

25. The protective shield as in claim 1, wherein the protective mesh comprises a plurality of openings there-through.

26. The protective shield as in claim 24, wherein the plurality of openings comprises a pattern of openings arranged in rows and in columns.

27. The spectrometer as in claim 17, wherein the protective mesh comprises a plurality of openings there-through.

28. The spectrometer as in claim 12, wherein the plurality of openings comprises a pattern of openings arranged in rows and in columns.

29. The method of using a spectrometer as in claim 20, wherein the protective mesh comprises a plurality of openings there-through.

30. The method of using a spectrometer as in claim 29, wherein the plurality of openings comprises a pattern of openings arranged in rows and in columns.
